(19) United States
(12) Patent Application Publication
(10) Pub. No.: US 2015/0100784 A1
(43) Pub. Date: Apr. 9, 2015

(54) COMMUNICATION APPARATUS AND CONTROL METHOD THEREFOR

(71) Applicant: CANON KABUSHIKI KAISHA, Tokyo (JP)

(72) Inventor: Tetsuo Ido, Yokohama-shi (JP)

(21) Appl. No.: 14/483,582

(22) Filed: Sep. 11, 2014

(30) Foreign Application Priority Data
Oct. 3, 2013 (JP) 2013-208621
Aug. 6, 2014 (JP) 2014-160804

(51) Int. Cl. H04L 9/32

(52) U.S. Cl. CPC H04L 9/3226
USPC 713/168

(57) ABSTRACT

Security parameter information for secure connection to a partner apparatus is generated. Routing information to the partner apparatus and address resolution information corresponding to the routing information are acquired, and managed in association with the security parameter information. In data transmission processing through the secure connection, validity/invalidity of the routing information or/and address resolution information associated with the security parameter information is determined. The data transmission processing is controlled based on the result of the determination processing.

### BACKGROUND OF THE INVENTION

1. Field of the Invention

The present invention relates to secure communication using cryptography.

2. Description of the Related Art

In recent years, there has been an increasing demand for ensuring the security of data transmission/reception through a computer network. IPsec (security architecture for Internet protocol) is a protocol for ensuring the security of data flowing on an IP network. In IPsec, it is possible to assure the confidentiality of data for each IP packet, verify the integrity of data, and authenticate a transmission source. Note that IPsec is defined in RFC2401 to RFC2412 and the like published by Internet Engineering Task Force (IETF).

A cryptographic communication apparatus incorporating an encryption/authentication function using IPsec performs cryptographic communication through a logical communication path. In IPsec, cryptographic communication parameters used for cryptographic communication, such as an encryption key and encryption algorithm and an authentication key and authentication algorithm, are managed as common parameters called SAs (security associations). A database for managing/holding the SAs is called an SAD (security association database).

The cryptographic communication apparatus using IPsec searches a security policy database (SPD) based on an IP address, a communication protocol, and the like to specify a security policy (SP). The cryptographic communication apparatus specifies SAs necessary for IPsec processing based on the specified SP, and transmits an IP packet having undergone encryption/authentication processing using the specified SAs.

Two cryptographic communication apparatuses using IPsec need to hold, in their SADs, SAs to be used with a communication partner, and establish SAs before IPsec communication is performed. An example of a method of establishing SAs is a manual key exchange method in which the users of the communication apparatuses manually set various kinds of information of the SAs. There is also provided an automatic key exchange method using an IKE (Internet key exchange) protocol. Note that IKE is defined in RFC2407 to RFC2409 and the like.

It is necessary to exchange an encryption algorithm and a common key prior to communication, and to often change the common key to maintain a security level. Therefore, the SA is managed using a validity period. When the validity period expires, the cryptographic communication apparatus rekeys an SA to generate a new SA.

On the other hand, routing information is required for packet transmission. The same applies to a packet added with an IP header for a tunnel in an IPsec tunnel mode. More specifically, the following processing procedure is performed.

A routing table is searched based on the destination IP address of a transmission packet, thereby deciding an IP address to which the packet is routed. The routing table is a set of path information entries for referring to the next transfer destination of the packet in order to allow the packet to reach the destination. In other words, by searching the routing table, it is decided whether the packet is transferred to an apparatus on a local network or a gateway (GW) for transferring the packet to another network.

When the next transfer destination of the packet is decided, an ARP (address resolution protocol) table is searched to acquire the MAC (media access control) address of the next transfer destination. The ARP table is a set of information entries each storing the correspondence between the MAC address and IP address of an apparatus on the network. First information obtained by searching the routing table and second information obtained by searching the ARP table based on the obtained first information may be collectively referred to as “routing information” hereinafter.

However, processing of searching the routing table to decide the next transfer destination of the packet, and acquiring S the MAC address of the transfer destination from the ARP table every time an IP packet is transmitted impose a heavy load. To solve this problem, there is proposed a method of temporarily storing routing information which has been searched for and acquired, and transmitting a packet based on the temporarily stored routing information without searching the routing table and ARP table every time a packet is transmitted. This method makes it possible to increase the speed of packet transmission processing, and reduce the processing load.

In packet transmission processing in secure communication, however, encryption processing is performed first, routing information is acquired by searching the routing table and ARP table next, and then a packet is transmitted. If, therefore, no routing information can be acquired, packet transmission processing is discarded, and the encryption processing and the routing information acquisition processing are wasted. Especially, the encryption processing and the routing information acquisition processing impose a heavy load, thus these processing exert a large influence. For example, by unnecessary execution of the encryption processing and the routing information acquisition processing, another processing is delayed.

### SUMMARY OF THE INVENTION

In one aspect, a communication apparatus comprising: a generation unit configured to generate security parameter information for secure connection to a partner apparatus; a management unit configured to acquire routing information to the partner apparatus and address resolution information corresponding to the routing information, and manage the routing information and the address resolution information in association with the security parameter information; a determination unit configured to determine, in data transmission processing through the secure connection, validity/invalidity of the routing information or/and the address resolution information associated with the security parameter information; and a control unit configured to control the data transmission processing based on a result of the determination.

According to the aspect, it is possible to control data transmission processing based on validity/invalidity of address resolution information or/and routing information to a partner apparatus to be secure-connected.

Further features of the present invention will become apparent from the following description of exemplary embodiments with reference to the attached drawings.

### BRIEF DESCRIPTION OF THE DRAWINGS

FIG. 1 is a block diagram showing the configuration of a system according to the first embodiment.

FIG. 2 is a block diagram showing the functional arrangement of a terminal.

FIG. 3 is a flowchart for explaining processing of generating and registering security parameter information.

FIG. 4 is a flowchart for explaining processing of transmitting data from the terminal to a partner terminal.

FIG. 5 is a block diagram showing the configuration of a system according to the second embodiment.

FIG. 6 is a flowchart for explaining processing of updating routing information and ARP resolution information which have been associated with security parameter information.

FIG. 7 is a block diagram showing the functional arrangement of a terminal according to the third embodiment.

FIG. 8 is a flowchart for explaining resolution request processing.

### DESCRIPTION OF THE EMBODIMENTS

A communication apparatus and a control method therefor according to each embodiment of the present invention will be described in detail below with reference to the accompanying drawings.

### First Embodiment

[Configuration of System]

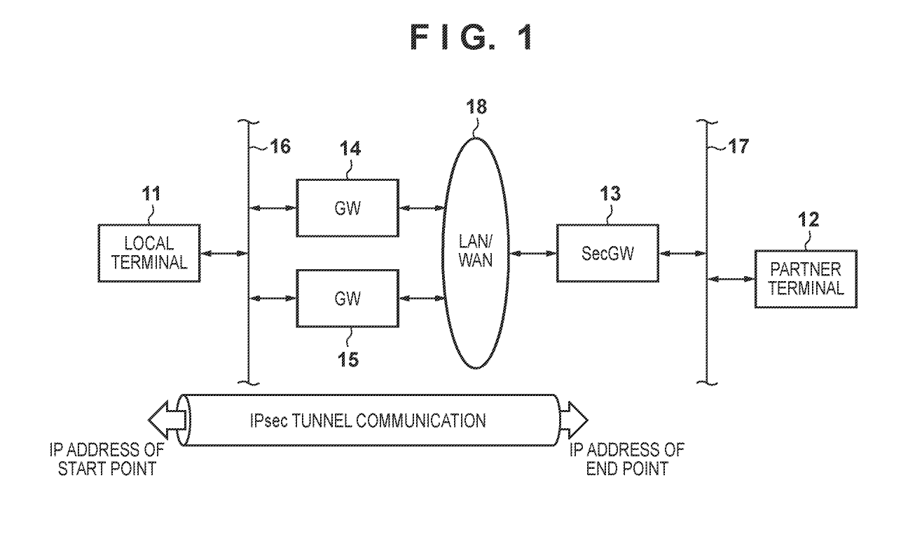

FIG. 1 is a block diagram showing the configuration of a system according to the first embodiment. In the first embodiment, a case in which a terminal 11 connected to a network 16 transmits data to a partner terminal 12 connected to another network 17 at an application level will be explained. For example, the terminal 11 is a digital camera, notebook type personal computer (PC), smartphone, tablet computer, or the like which can access the network. The partner terminal 12 is a server apparatus or the like.

Data transmitted from the terminal 11 to the partner terminal 12 is, for example, image data. To transmit data, the terminal 11 constructs secure communication paths in the IPsec tunnel mode with a gateway (GW) 14 or 15 of the network 16 and a security gateway (SecGW) 13 through a local area network (LAN) or wide area network (WAN) 18. The SecGW 13 is a partner apparatus to which the terminal 11 is secure-connected. Note that the local network 16 to which the terminal 11 is connected may be a wired or wireless LAN.

[Arrangement of Apparatus]

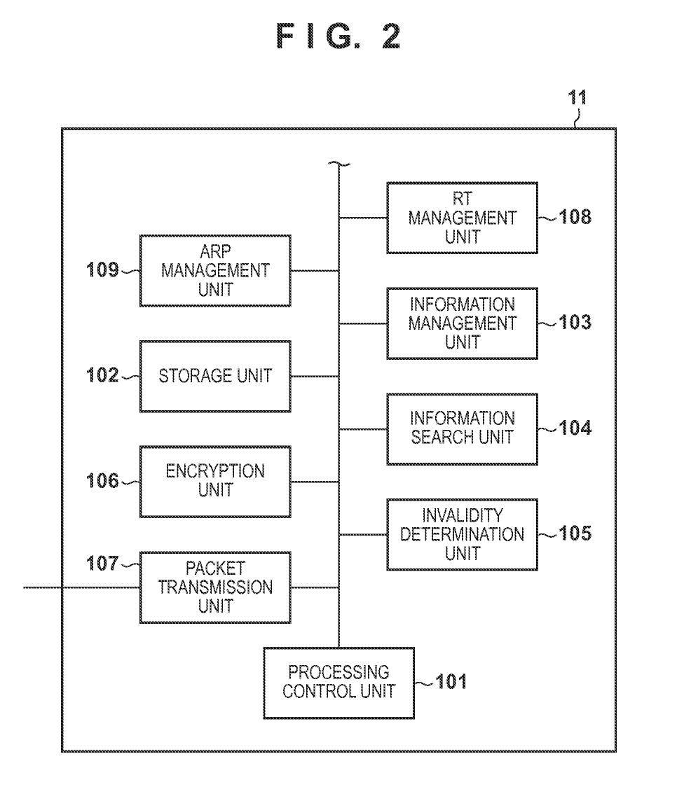

FIG. 2 is a block diagram showing the functional arrangement of the terminal 11. A processing control unit 101 controls the overall processing of the terminal 11, and a processing order in packet transmission processing. A storage unit 102 stores user data, intermediate data generated by various processes, and the like, and also stores security parameter information, routing information of a partner terminal to be secure-connected, ARP resolution information for the routing information, and the like.

An information management unit 103 stores routing information and ARP resolution information corresponding to security parameter information in association with each other in the storage unit 102, and manages the associated pieces of information. When given security parameter information is designated, the information management unit 103 can indicate the reference destination of associated routing information and ARP resolution information.

An information search unit 104 searches for security parameter information which matches a search condition from a set of pieces of security parameter information stored in the storage unit 102. The search condition is secure connection information such as a secure connection partner destination address and a port number. An invalidity determination unit 105 determines validity/invalidity of the routing information and ARP resolution information indicated by the information management unit 103.

An encryption unit 106 encrypts or tunnels part or all of a packet. In other words, in the IPsec tunnel mode, processing of encrypting all of an original packet including a header portion and adding a tunnel IP header is performed. In the IPsec transport mode, processing of encrypting the data portion of a packet and adding an IPsec header is performed. In other words, the encryption unit 106 performs processing according to the setting and mode of IPsec.

A packet transmission unit 107 performs processing of transmitting a packet using routing information and ARP resolution information corresponding to the packet. In other words, the packet transmission unit 107 performs processing of, for example, transmitting an Ethernet® frame generated from the ARP resolution information to the network 16 such as Ethernet®. In wireless LAN communication, a wireless LAN frame is generated and transmitted.

A routing table management unit (to be referred to as an “RT management unit” hereinafter) 108 acquires neighboring routing information from another apparatus connected to the network 16. The RT management unit 108 registers the acquired routing information in the storage unit 102, and manages, as a routing table, the routing information registered in the storage unit 102.

An ARP table management unit (to be referred to as an “ARP management unit” hereinafter) 109 registers ARP resolution information in the storage unit 102, and manages, as an address resolution information table (to be referred to as an “ARP table” hereinafter), the ARP resolution information registered in the storage unit 102. If the ARP management unit 109 searches the ARP table, and cannot find ARP resolution information, it transmits an ARP request, and registers, in the ARP table of the storage unit 102, ARP resolution information included in a response to the ARP request.

[Processing]

Assume that the terminal 11 constructs a secure communication path in the IPsec tunnel mode up to the SecGW 13 through the GW 14. Assume also that the destination of user data is the partner terminal 12 connected at the succeeding stage of the SecGW 13. Note that processing to be described below is executed when the processing control unit 101 controls another arrangement of the terminal 11.

Generation and Registration of Security Parameter Information

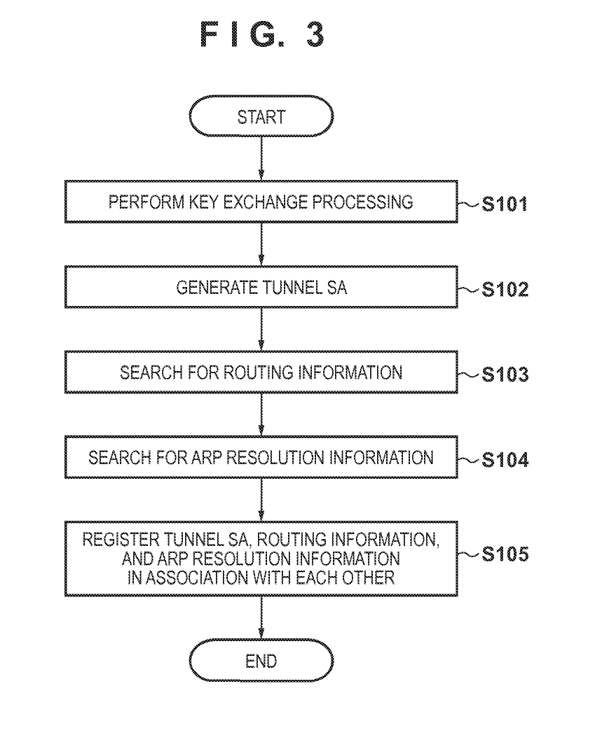

Processing of generating and registering security parameter information in the terminal 11 will be described with reference to a flowchart shown in FIG. 3. Note that the processing shown in FIG. 3 is executed when the processing control unit 101 controls another arrangement of the terminal 11.

To construct an IPsec tunnel, the processing control unit 101 performs key exchange processing using the IKE protocol or the like with the SecGW 13 as a secure connection partner (S101). Note that the IKE protocol is a protocol for generating security parameter information (SA) shared with a secure connection partner.

The processing control unit 101 generates a tunnel SA based on security parameter information obtained as a result of the key exchange processing (S102). Generation of a tunnel SA need not depend on the IKE protocol, as a matter of course. For example, a tunnel SA may be generated when the user of the terminal 11 sets security parameter information. In this case, the key exchange processing in step 5101 becomes unnecessary.

When the tunnel SA is generated, the information management unit 103 searches the routing table managed by the RT management unit 108 for routing information for which the SecGW 13 as a secure connection partner is set as a target (S103). In other words, using the IP address of the SecGW 13 as a search condition, the routing table is searched for the next transmission destination IP address to reach the SecGW 13. If, as a result of the search processing, the GW 14 is detected as the next transmission destination, routing information indicates the IP address of the GW 14. If no next transmission destination is detected, information indicating non-detection or information including an IP address “0.0.0.0” indicating invalidity of routing information is obtained as a routing information search result. Alternatively, a flag may be used to indicate invalidity of routing information.

The information management unit 103 searches the ARP table managed by the ARP management unit 109 for ARP resolution information of the GW 14 indicating by the routing information (S104). In other words, the ARP table is searched for the ARP resolution information using the IP address of the GW 14 as a search condition. If the MAC address of the GW 14 is detected as a result of the search processing, the MAC address serves as ARP resolution information. If no ARP resolution information is detected, information indicating non-detection or information including a MAC address “00:00:00:00:00:00” indicating invalidity of ARP resolution information is obtained as an ARP resolution information search result. Alternatively, a flag may be used to indicate invalidity of ARP resolution information.

If both the routing information and the ARP resolution information are obtained, the information management unit 103 associates the tunnel SA generated in step 5102, the routing information, and the ARP resolution information with each other, and registers them in the storage unit 102 (S105). In other words, the information management unit 103 manages the information so that the routing information and ARP information which have been associated with the tunnel SA can be decided when the tunnel SA is designated later. As described above, for example, an IP address except for “0.0.0.0” indicates valid routing information, and a MAC address except for “00:00:00:00:00:00” indicates valid ARP resolution information.

Data Transmission Processing

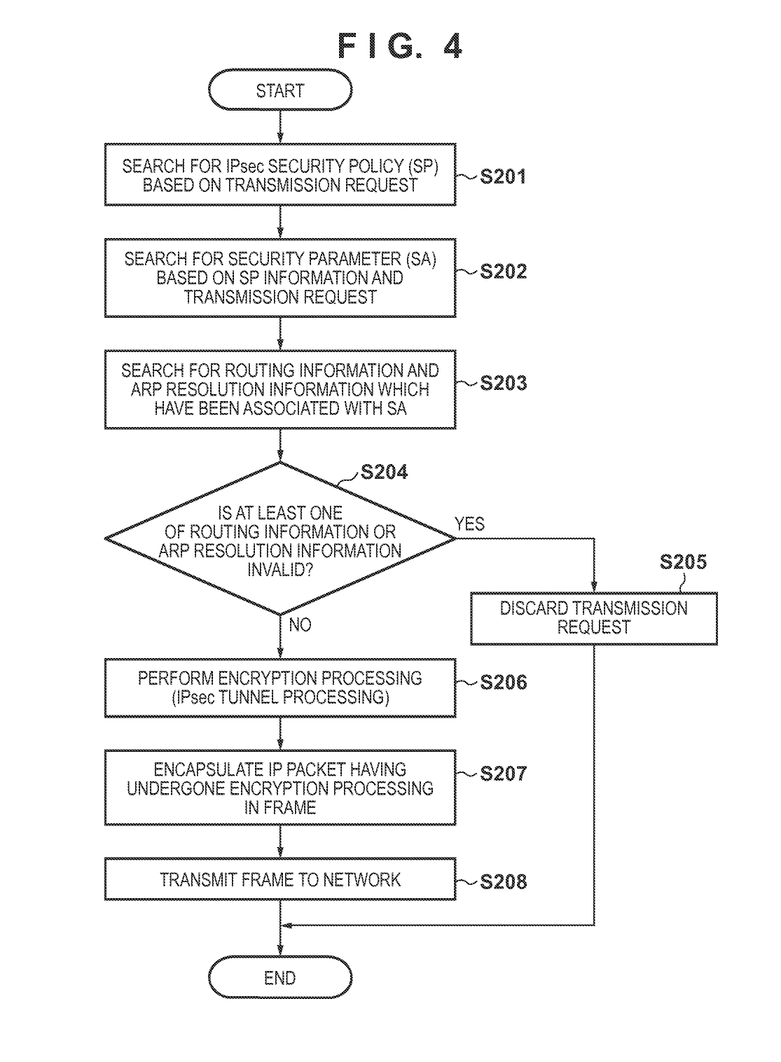

Processing of transmitting data from the terminal 11 to the partner terminal 12 will be described with reference to a flowchart shown in FIG. 4. The data transmission processing shown in FIG. 4 is executed when a request to transmit user data stored in the storage unit 102 of the terminal 11 is issued to the processing control unit 101.

The processing control unit 101 searches for an IPsec security policy (SP) based on a communication protocol and destination information indicated by a transmission request (S201). In other words, the processing control unit 101 searches an SP database (SPD) for SP information corresponding to the transmission request. The SP information indicates whether IPsec is applied. In this example, assume that the SP information indicates IPsec application.

The processing control unit 101 searches for a security parameter using the information search unit 104 (S202). In other words, the processing control unit 101 searches the SA database (SAD) for a corresponding security parameter using the SP information and the destination information indicated by the transmission request as search conditions. Note that the tunnel SA generated for secure connection to the SecGW 13 is detected as a security parameter.

The processing control unit 101 controls the information management unit 103 to search for the routing information and ARP resolution information which have been associated with the tunnel SA detected by the information search unit 104, and to output the detected routing information and ARP resolution information to the invalidity determination unit 105 (S203).

The processing control unit 101 determines whether the determination result of the invalidity determination unit 105 indicates invalidity of at least one of the routing information or ARP resolution information (S204). If the determination result indicates invalidity of at least one of the routing information or ARP resolution information, the processing control unit 101 discards the transmission request (S205), and terminates the data transmission processing. On the other hand, if the determination result of the invalidity determination unit 105 indicates that neither the routing information nor the ARP resolution information is invalid (in other words, the determination result indicates validity of both the pieces of information), the process advances to step S206.

If the determination result of the invalidity determination unit 105 indicates validity of both the pieces of information, the processing control unit 101 controls the encryption unit 106 to perform encryption processing (IPsec tunnel processing) (S206). At this time, the tunnel SA detected by the information search unit 104, the routing information, and the ARP resolution information have been decided. The encryption unit 106 uses the tunnel SA detected by the information search unit 104 for IPsec encryption processing. Furthermore, an IPsec tunnel mode header is added at this time.

When an IP packet having undergone encryption processing is generated, the packet transmission unit 107 performs processing of encapsulating the IP packet having undergone encryption processing in an Ethernet® frame (S207). At this time, the tunnel SA, routing information, and ARP resolution information have been decided. The packet transmission unit 107 performs encapsulating processing using the ARP resolution information. In other words, the packet transmission unit 107 generates a MAC header using the MAC address of the next transmission destination as the ARP resolution information, thereby generating an Ethernet® frame.

The packet transmission unit 107 transmits the generated Ethernet® frame to the network 16 (S208). Note that when the terminal 11 is connected to a wireless LAN, the packet transmission unit 107 generates a wireless LAN packet instead of the Ethernet® frame, and transmits the generated wireless LAN packet to the wireless LAN.

As described above, prior to the encryption processing, it is possible to determine validity/invalidity of the routing information or/and ARP resolution information. When the data transmission processing is discarded, it is possible to prevent at least the encryption processing (S206) from being unnecessarily executed.

If routing information and ARP resolution information are valid and data can be transmitted, it is possible to acquire the routing information and ARP resolution information based on security policy (SP) search processing and security parameter search processing. In other words, it is possible to perform data transmission processing without additionally executing processing of searching the routing table or ARP table.

### Second Embodiment

A communication apparatus and a control method therefor according to the second embodiment of the present invention will be described below. Note that in the second embodiment, the same reference numerals as those in the first embodiment denote the same components and a detailed description thereof will be omitted.

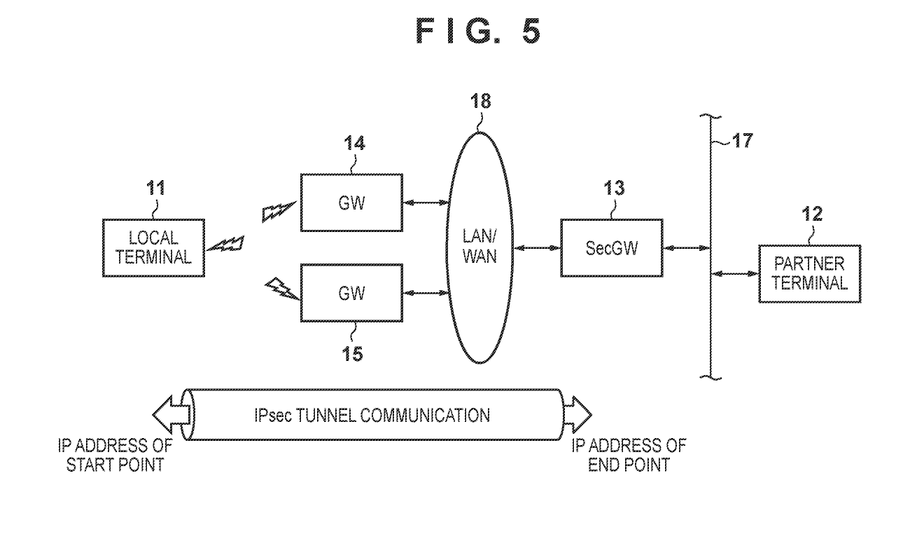

FIG. 5 is a block diagram showing the configuration of a system according to the second embodiment. In the second embodiment, a case will be explained in which the gateway of an IPsec tunnel communication section is switched from a GW 14 to a GW 15 during the data transmission processing described in the first embodiment. This situation assumes, for example, a case in which a network 16 connected to a terminal 11 is a wireless LAN, and the terminal 11 moves from a wireless communication area where the terminal 11 is connected to the GW 14 to a wireless communication area where the terminal 11 is connected to the GW 15. Alternatively, a case is assumed in which the gateway is switched from the GW 14 to the GW 15 because of maintenance or a failure of the GW 14 regardless of whether the network 16 is a wireless or wired LAN. A case will be described below in which the terminal 11 moves from the wireless communication area of the GW 14 to that of the GW 15, and thus the gateway is switched from the GW 14 to the GW 15.

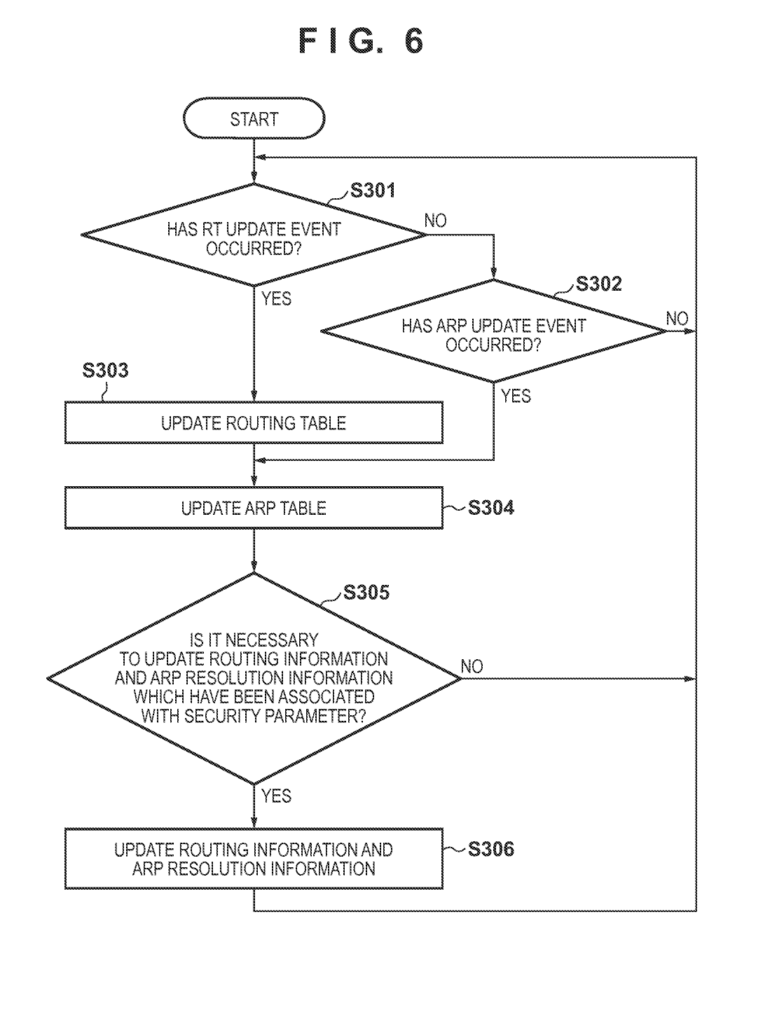

Processing of updating routing information and ARP resolution information which have been associated with security parameter (SA) information will be explained with reference to a flowchart shown in FIG. 6. The terminal 11 is connected to the GW 14 through a wireless LAN, and secure-connected to a SecGW 13 by establishing IPsec tunnel communication. The transmission destination of user data is a partner terminal 12. In this situation, an RT management unit 108 acquires neighboring routing information from the GW 14 or another terminal, and manages the neighboring routing information by a routing table. The neighboring routing information includes routing information for the GW 15.

In this state, the terminal 11 moves to leave the wireless communication area of the GW 14 and enter the wireless communication area of the GW 15. Thus, the connection destination of wireless LAN communication is switched to the GW 15. By using, as a trigger, the occurrence of so-called roaming in which the connection destination of wireless LAN communication is switched, the RT management unit 108 acquires the routing information of the GW 15 by a protocol for searching for the routing information for the wireless LAN network of the GW 15. The routing information of the GW 15 is managed by the routing table.

The RT management unit 108 determines whether an event (to be referred to as an “RT update event” hereinafter) to update the routing table has occurred (in the above example, whether roaming has occurred) (S301). If no RT update event has occurred, an ARP management unit 109 determines whether an event (to be referred to as an “ARP update event” hereinafter) to update an ARP table has occurred (S302). If neither an RT update event nor ARP update event has occurred, the process returns to step 5301 to monitor the occurrence of the events.

If an RT update event has occurred, the RT management unit 108 updates the routing table, as described above (S303). If an RT update event or ARP update event has occurred, the ARP management unit 109 acquires ARP resolution information of an IP address added or updated in the routing table, and updates the ARP table with the acquired ARP resolution information (S304).

If the routing table or ARP table is updated, an information management unit 103 determines whether it is necessary to update routing information and ARP resolution information which have been associated with a security parameter (S305). If it is necessary to update the routing information and ARP information, the information management unit 103 updates these pieces of information (S306). After that, the process returns to step 5301 to monitor the occurrence of an RT update event and ARP update event. Detailed processes in steps 5305 and 5306 are as follows.

If the routing table is updated, the RT management unit 108 notifies the information management unit 103 of the occurrence of an RT update event, routing information before update, and routing information after update. Upon receiving the notification, the information management unit 103 searches the managed information for the routing information before update. If the information management unit 103 detects the routing information before update (it is necessary to update the routing information), it updates the routing information with the routing information after update. If the notification of the RT management unit 108 indicates that it is impossible to acquire the routing information after update, the detected routing information is rewritten by information indicating invalidity.

In other words, when the gateway is switched from the GW 14 to the GW 15, the information management unit 103 searches for routing information having the IP address of the GW 14, and rewrites the IP address of the detected routing information by the IP address of the GW 15. With this processing, routing information associated with a tunnel SA for secure connection to the SecGW 13 is updated with the IP address of the GW 15.

If the routing information is updated, it is also necessary to update the ARP resolution information. In other words, the information management unit 103 acquires the MAC address of the GW 15 from the ARP management unit 109, and rewrites ARP resolution information associated with the tunnel SA for secure connection to the SecGW 13 by the MAC address of the GW 15.

If only the ARP table is updated, the ARP management unit 109 notifies the information management unit 103 of the occurrence of an ARP update event, ARP resolution information before update, and ARP resolution information after update. Upon receiving the notification, the information management unit 103 searches the managed information for the ARP resolution information before update. If the information management unit 103 detects the ARP resolution information before update (it is necessary to update the ARP resolution information), it updates the ARP resolution information by the ARP resolution information after update. If the notification of the RT management unit 108 indicates deletion as the ARP resolution information after update, the information management unit 103 rewrites the detected ARP resolution information by information indicating invalidity.

In other words, when the gateway is switched from the GW 14 to the GW 15, the information management unit 103 searches for ARP resolution information having the MAC address of the GW 14, and rewrites the MAC address of the detected ARP resolution information by the MAC address of the GW 15. With this processing, ARP resolution information associated with the tunnel SA for secure connection to the SecGW 13 is updated with the MAC address of the GW 15.

Data transmission processing is executed according to the flowchart shown in FIG. 4. The routing information and ARP resolution information which have been associated with the tunnel SA are referred to. If at least one of the pieces of information is determined to be invalid, the data transmission processing is discarded. With the above-described update processing, the routing information and ARP resolution information are updated by setting the GW 15 as a target. Therefore, both the pieces of information are valid, and the data transmission processing is continued.

As described above, even if at least one of the routing information or ARP resolution information is updated, it is possible to determine validity/invalidity of the routing information or ARP resolution information prior to encryption processing. Therefore, when the data transmission processing is discarded, it is possible to prevent at least the encryption processing (S206) from being unnecessarily executed.

### Third Embodiment

A communication apparatus and a control method therefor according to the third embodiment of the present invention will be described below. Note that in the third embodiment, the same reference numerals as those in the first and second embodiments denote the same components and a detailed description thereof will be omitted.

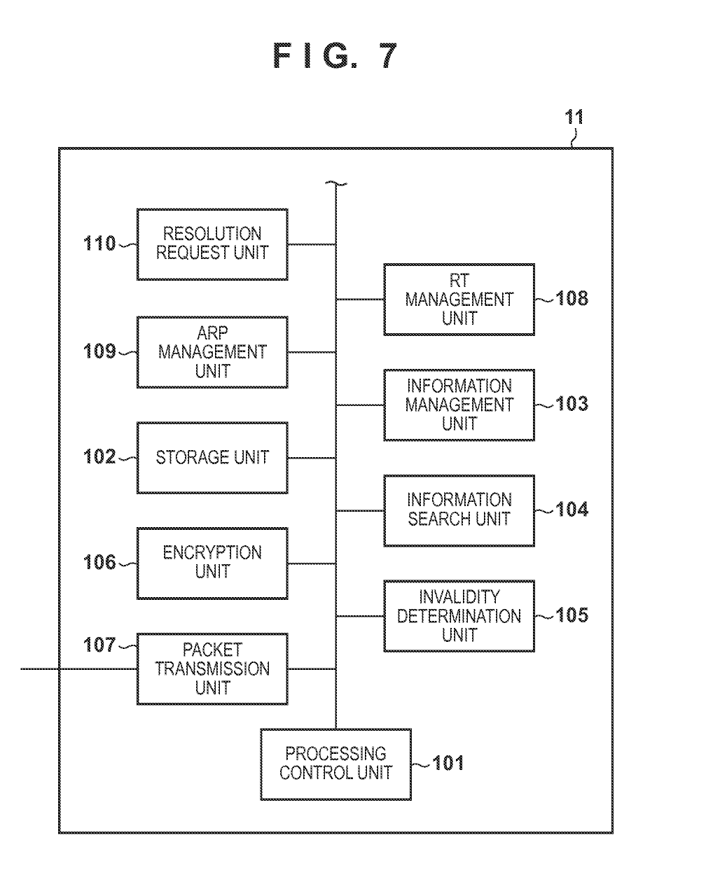

FIG. 5 is a block diagram showing the configuration of a system according to the third embodiment. Furthermore, FIG. 7 is a block diagram showing the functional arrangement of a terminal 11 according to the third embodiment. The difference from the functional arrangement shown in FIG. 2 is that a resolution request unit 110 is added in the functional arrangement shown in FIG. 7.

If the determination result of an invalidity determination unit 105 indicates invalidity of at least one of routing information or ARP resolution information, the resolution request unit 110 receives an instruction of a processing control unit 101, and issues a resolution request to an information management unit 103. If the routing information is invalid, the resolution request includes information indicating that the routing information should be resolved. If the ARP resolution information is invalid, the resolution request includes information indicating that the ARP resolution information should be resolved.

Upon receiving the resolution request indicating that the routing information should be resolved, the information management unit 103 instructs an RT management unit 108 to execute routing information resolution processing. The RT management unit 108 performs, for example, processing of acquiring neighboring routing information from another apparatus connected to a network.

Upon receiving the resolution request indicating that the ARP resolution information should be resolved, the information management unit 103 instructs an ARP management unit 109 to execute ARP resolution information resolution processing. The ARP management unit 109 executes, for example, processing of transmitting an ARP request and receiving a response.

In the third embodiment, a case will be described in which the gateway of an IPsec tunnel communication section is switched from a GW 14 to a GW 15 during data transmission processing, similarly to the case explained in the second embodiment. Note that there is the following difference from the second embodiment. In other words, the validity period of ARP resolution information expires at the time of switching, and the ARP resolution information is invalid.

Processing of issuing a resolution request when at least one of routing information or ARP resolution information associated with security parameter (SA) information is invalid will be described below.

As described in the second embodiment, when the terminal 11 moves to leave the wireless communication area of the GW 14 and enter the wireless communication area of the GW 15, the RT management unit 108 acquires the routing information of the GW 15 by a protocol for searching for the routing information for the wireless LAN network of the GW 15 using the occurrence of roaming as a trigger. The routing information of the GW 15 is managed by a routing table.

If the routing table is updated, the RT management unit 108 notifies the information management unit 103 of the occurrence of an RT update event, routing information before update, and routing information after update. Upon receiving the notification, the information management unit 103 searches managed information for the routing information before update. If the information management unit 103 detects the routing information before update (it is necessary to update the routing information), it updates the routing information with the routing information after update. If the notification of the RT management unit 108 indicates that it is impossible to acquire the routing information after update, the detected routing information is rewritten by information indicating invalidity. In the third embodiment, the following description assumes that the routing information is not rewritten by information indicating invalidity.

If routing information is updated, it is also necessary to update ARP resolution information. In other words, the information management unit 103 acquires the MAC address of the GW 15 from the ARP management unit 109, and rewrites ARP resolution information associated with a tunnel SA for secure connection to a SecGW 13 by the MAC address of the GW 15.

If only an ARP table is updated, the ARP management unit 109 notifies the information management unit 103 of the occurrence of an ARP update event, ARP resolution information before update, and ARP resolution information after update. Upon receiving the notification, the information management unit 103 searches managed information for the ARP resolution information before update. If the information management unit 103 detects the ARP resolution information before update (it is necessary to update the ARP resolution information), it updates the ARP resolution information by the ARP resolution information after update. If the notification of the RT management unit 108 indicates deletion as the ARP resolution information after update, the information management unit 103 rewrites the detected ARP resolution information by information indicating invalidity. In the third embodiment, the following description assumes that ARP resolution has failed and the ARP resolution information has been rewritten by information indicating invalidity. Assume also that the reason why ARP resolution has failed is because it is impossible to perform wireless LAN communication due to noise, and ARP resolution is possible at another opportunity.

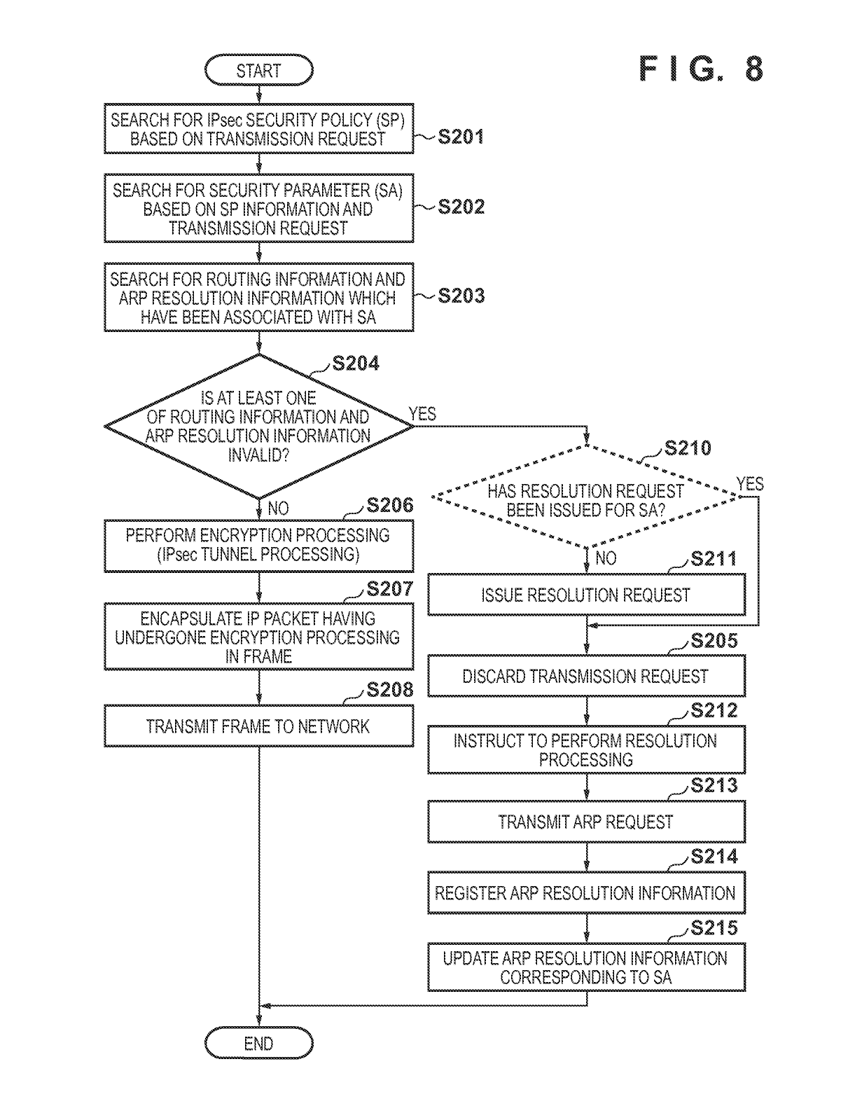

Resolution request processing will be described with reference to a flowchart shown in FIG. 8. Note that in FIG. 8, the same reference symbols as those in FIG. 4 denote the same processes and a detailed description thereof will be omitted.

Data transmission processing is performed according to a sequence shown in FIG. 8, and routing information and ARP resolution information which have been associated with a tunnel SA are referred to. In this example, since the invalidity determination unit 105 determines that the ARP resolution information is invalid (S204), the processing control unit 101 instructs the resolution request unit 110 to issue a resolution request. Note that processing in step 5210 will be described later. Upon receiving the resolution request issuance instruction, the resolution request unit 110 issues an ARP resolution information resolution request to the information management unit 103 (S211). The processing control unit 101 discards a transmission request (S205), and terminates the data transmission processing, similarly to the second embodiment.

On the other hand, upon receiving the resolution request, the information management unit 103 instructs the ARP management unit 109 to perform resolution processing (S212). In response to the instruction, the ARP management unit 109 transmits an ARP request (S213). If the ARP management unit 109 can receive an ARP response, and obtain ARP resolution information, it registers the obtained ARP resolution information in a storage unit 102 (S214). The information management unit 103 updates ARP resolution information corresponding to security parameter information (SA) (S215).

The resolution request unit 110 may manage whether a resolution request has been issued for each piece of security parameter information (SA) so as not to continuously issue a resolution request, and prevent multiple resolution requests from being issued. In other words, the resolution request unit 110 is controlled not to repeatedly issue a resolution request for security parameter information (SA) for which a resolution request has already been issued (S210).

If a next transmission request is issued by data retransmission mechanism, ARP resolution information is valid at this time, and thus the data transmission processing is continued without discarding a transmission request.

As described above, if it is determined that routing information or ARP resolution information is invalid, it is possible to quickly resolve invalid information by issuing a resolution request. With this processing, it is possible to restart data transmission processing by resolving routing information or ARP resolution information, even if routing information or ARP resolution information is temporarily invalid.

When it is temporarily determined that routing information or ARP resolution information is invalid but information can be actually resolved, it is possible to prevent a transmission request from being unnecessarily, continuously discarded.

### Other Embodiment

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)TM), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2013-208621 filed October 3, 2013 and No. 2014-160804 filed Aug. 6, 2014 which are hereby incorporated by reference herein in their entirety.

What is claimed is:

1. A communication apparatus comprising:
a generation unit configured to generate security parameter information for secure connection to a partner apparatus;
a management unit configured to acquire routing information to the partner apparatus and address resolution information corresponding to the routing information, and manage the routing information and the address resolution information in association with the security parameter information;
a determination unit configured to determine, in data transmission processing through the secure connection, validity/invalidity of the routing information or/and the address resolution information associated with the security parameter information; and
a control unit configured to control the data transmission processing based on a result of the determination,
wherein at least one of the generation unit, the management unit, the determination unit, or the control unit is implemented using a processor.

2. The apparatus according to claim 1, wherein in a case where no routing information to the partner apparatus is acquired, the management unit manages information indicating invalidity of routing information in association with the security parameter information.

3. The apparatus according to claim 1, wherein in a case where no address resolution information corresponding to the routing information is acquired, the management unit manages information indicating invalidity of address resolution information in association with the security parameter information.

4. The apparatus according to claim 1, wherein the determination unit performs determination before encryption processing in the data transmission processing.

5. The apparatus according to claim 4, further comprising an encryption unit configured to perform the encryption processing based on the security parameter information.

6. The apparatus according to claim 1, wherein in a case where it is determined that at least one of the routing information or the address resolution information is invalid, the control unit discards the data transmission processing.

7. The apparatus according to claim 1, wherein in a case where it is determined that the routing information and the address resolution information are valid, the control unit continues the data transmission processing.

8. The apparatus according to claim 1, further comprising:
a first table management unit configured to manage a routing table in which routing information is registered; and
a second table management unit configured to manage an address resolution information table in which address resolution information is registered,
wherein the management unit acquires routing information from the routing table, and acquires address resolution information from the address resolution information table.

9. The apparatus according to claim 8, wherein the first table management unit detects a routing information update event, and the second table management unit detects an address resolution information update event,
in a first case where the routing information update event is detected, the first table management unit updates the routing table, and the second table management unit updates the address resolution information table, and
in a second case where the address resolution information update event is detected, the second table management unit updates the address resolution information table.

10. The apparatus according to claim 9, wherein in the first case where the routing table is updated, the management unit determines whether it is necessary to update the routing information managed in association with the security parameter information, and
in a case where it is necessary to update the routing information, the management unit updates the routing information and address resolution information which are managed in association with the security parameter information.

11. The apparatus according to claim 9, wherein in the second case where the routing table is not updated but the address resolution information table is updated, the management unit determines whether it is necessary to update the address resolution information managed in association with security parameter information, and
in a case where it is necessary to update the address resolution information, the management unit updates the address resolution information managed in association with the security parameter information.

12. The apparatus according to claim 1, further comprising a resolution request unit configured to issue a resolution request for routing information or/and address resolution information,
wherein in a case where the determination unit determines that at least one of the routing information or the address resolution information associated with the security parameter information is invalid, the resolution request unit issues the resolution request, and the management unit executes processing of acquiring routing information or/and address resolution information based on the resolution request.

13. The apparatus according to claim 1, wherein the resolution request unit manages whether a resolution request has been issued for each piece of security parameter information so as to control not to repeatedly issue a resolution request for security parameter information for which a resolution request has already been issued.

14. A control method of a communication apparatus comprising:
using a processor to perform steps of:
generating security parameter information for secure connection to a partner apparatus;
acquiring routing information to the partner apparatus and address resolution information corresponding to the routing information;
managing the routing information and the address resolution information in association with the security parameter information;
determining, in data transmission processing through the secure connection, validity/invalidity of the routing information or/and the address resolution information associated with the security parameter information; and
controlling the data transmission processing based on a result of the determination.

15. A non-transitory computer readable medium storing a computer-executable program for causing a computer to perform a control method of a communication apparatus, the method comprising steps of:
generating security parameter information for secure connection to a partner apparatus;
acquiring routing information to the partner apparatus and address resolution information corresponding to the routing information;
managing the routing information and the address resolution information in association with the security parameter information;
determining, in data transmission processing through the secure connection, validity/invalidity of the routing information or/and the address resolution information associated with the security parameter information; and
controlling the data transmission processing based on a result of the determination.
